(19) United States
(12) Patent Application Publication
(10) Pub. No.: US 2018/0009172 A1
(43) Pub. Date: Jan. 11, 2018

(54) METHOD, EQUIPMENT AND MATERIAL FOR 3D PRINTING AND DEPOSITION ON A SURFACE OR OBJECT WITH STRONG BOND

(71) Applicants: Rakshit Amba, East Greenbush, NY (US); Jai Prashant Amba, East Greenbush, NY (US)

(72) Inventors: Rakshit Amba, East Greenbush, NY (US); Jai Prashant Amba, East Greenbush, NY (US)

(21) Appl. No.: 15/494,427

(22) Filed: Apr. 21, 2017

Related U.S. Application Data
(60) Provisional application No. 62/325,725, filed on Apr. 21, 2016.

(51) Int. Cl. B29C 64/40; B33Y 30/00; B29C 64/124; B29C 64/223; B33Y 10/00

(52) U.S. Cl. CPC B29C 64/40; B33Y 30/00; B33Y 10/00; B29C 64/223; B29C 64/124

(57) ABSTRACT

Three-dimensional effect or structure with a strong bond may be achieved on any surface such as on wood, stone, paper, ceramic, and rubber/polymer, sponge/foam, cloth, and glass, cement, building structures or metals. Before application of tile 3D structure, the surface is first prepared with at least on a layer that can bind a subsequent layer. This tie (compatible) layer material may comprise of the adhesive layer and another tie (compatible) layer such as thermoplastic film or coating. 3D printing filament materials with a different set of properties are combined using unique methods, apparatus to produce new structures, effects or parts with a unique combination of properties. Continuous application of tie layer and 3D printing for unique small or large objects can be achieved.

### CROSS REFERENCE TO RELATED APPLICATION

This application claims priority to U.S. Provisional Patent Application No. 62/325,725 filed on Apr. 21, 2016, which is incorporated herein in its entirety by reference.

### TECHNICAL FIELD

The present disclosure relates to a method for 3D priming, more particularly to a method for 3D printing of a new structure or an effect on a surface.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the drawings that form a part of this document: Copyright 2016, Yogamba, LLC. All Rights Reserved.

### BACKGROUND

U.S. Pat. No. 5,121,329 describes apparatus for controlled depositing layers using a movable dispensing head which solidifies at a predetermined temperature. This method is only limited to depositing material on to the previous layer of the same material. This can be single or multiple materials for a defined CAD structure or surface effect. The material can be fluid, stream of particles that may solidify to create the surface effect or structure. These materials comprise of thermoplastic resins, self-hardening waxes, molten metals, foaming plastics, two-part-epoxies, glass, photo-curable polymers, glass/mineral/functional/appearance plastics or combinations thereof The three-dimensional build-up may or may not need a support structure. The material may comprise of single or multiple colors, properties, or material types to produce desired effect or function. Providing adequate bond upon solidification.

Layered object manufacturing described in publication EP 2225045 B1, describes controlled adhesive application on to multiple layers of a paper substrate to generate a three-dimensional object. The additive manufacturing can be a combination of multiple film layer addition and 3D printing between each layer to create specific structure or effect.

### SUMMARY

This disclosure relates primarily to a method for 3D printing. The method includes preparation of at least e layer and deposition of at least care material. The layer is adapted to bind subsequent layers; the layer includes an adhesive layer and a compatible layer. The deposition of at least one material, where materials are combined in a fixed amount, the materials are fed into a deposition tool head, the deposition tool head is adapted to produce a predefined structure, the predefined structure includes an article and an effect. The layer may comprise a thermoplastic film or a coating. The 3D printing may be done on any surface such as on wood, stone, paper, ceramic, rubber, polymer, sponge, foam, cloth, glass, cement or metals.

In an example embodiment, the disclosure provides a method for 3D printing including layering and deposition of materials on a surface to produce a new structure or an effect.

In an example embodiment, the disclosure provides a method for 3D priming including layering that is capable of binding subsequent layers.

In an example embodiment, the disclosure provides a method for 3D printing including deposition of materials on a surface having a fixed amount of different types of materials.

In another example embodiment, the disclosure provides a method for 3D printing including a deposition tool adapted to deposit the material on the surface.

In yet another example embodiment, the disclosure provides a method for 3D printing where the surface can be selected from at least one of wood, stone, paper, ceramic, rubber, polymer, sponge, foam, cloth, glass, cement or metals.

In an example embodiment, a method for three-dimensional printing comprises:

preparing a surface of a pre-made object by depositing at least one adhesive layer on the surface, wherein the adhesive layer is adapted to bind the surface of the object with a compatible layer;
depositing the compatible layer on the adhesive layer,
three-dimensional printing on the prepared surface by, depositing at least a first material on the compatible layer by a deposition tool head to create a predefined structure on the pre-made object, the predefined structure including an article and an effect.

In another example embodiment, a method for three-dimensional printing, the method comprises: in a first step,

preparing a first surface of a first object by depositing at least one first adhesive layer on the surface, wherein the first adhesive layer is adapted to bind the surface of the first object with a first compatible layer; depositing the first compatible layer on the first adhesive layer; three-dimensional printing on the prepared first surface by, depositing at least a first material on the first compatible layer by a first deposition tool head to create a predefined structure on the first object, the predefined structure including a first article or a first effect;
in a second step,
preparing a second surface of the predefined object by depositing at least second adhesive, wherein the second adhesive layer is adapted to bind a third surface of premade article preparing a third surface of a pre-made article by depositing at least one third adhesive layer on the third surface, wherein the third adhesive layer is adapted to bind the third surface of the pre-made article object with the second surface of the predefined object; attaching the third surface of the pre-made article with the prepared second surface of the predefined object; and
repeating a combination of the first step and second step to obtain the desired effect and a composite article.

In yet another example embodiment, a method for three-dimensional printing comprises: forming a partial structure of a first object by a combination of inline built thermoforming or stamping tool and CNC (Computer Numerical Control) use of position coordinates; preparing a first surface of a first object by depositing at least one first adhesive layer on the first surface, wherein the first adhesive layer is adapted to bond the first surface of the first object with a first compatible layer; depositing the first compatible layer on the first adhesive layer; three-dimensional printing on the prepared surface by,

depositing at least a first material on the first compatible layer by a first deposition tool head to create a first predefined structure on the first object, the predefined structure including a first article or a first effect; preparing a second surface of a second object by depositing at least one-second adhesive layer on the second surface, wherein the second adhesive layer is adapted to bind the second snake of the second object with a second compatible layer;
depositing the second compatible layer on the second adhesive layer;
depositing at least a second material on the second compatible layer by a second deposition tool head to create a second predefined structure on the second object, the second predefined structure including a second article or a second effect.

In yet another example embodiment, the disclosure provides a method for 3D printing having an adhesive layer selected from but not limited to ethylene vinyl acetate copolymer (EVA) and thermoplastic polyurethane (TPU) and silicone that can be cured at room temperature or autoclave.

Another aspect of the disclosure is to provide depositing materials including thermoplastic resins, self-hardening waxes, molten metals, foaming plastics, two part epoxies, glass, photo-curable polymers, glass/mineral/functional/appearance plastics or combinations thereof.

These and other embodiments may become more apparent to those skills in the art upon review of the summary of the disclosure as provided herein, and upon undertaking a study of the description of its embodiment, in view of the drawings.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

These together with other objects of the disclosure, along with the various features of novelty which characterize the disclosure, are pointed out with particularity in the disclosure. For a better understanding of the disclosure, its operating advantages and the specific objects attained by its uses, reference should be made to the accompanying drawings and descriptive matter in which there are illustrated preferred embodiments of the disclosure.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various examples discussed in the present document. In the drawings:

FIG. 1 shows an isometric view of 3D printed flower design, frame support, and base according to an example embodiment.

FIG. 2A shows an isometric view of 3D printed table, according to an example embodiment.

FIG. 2B shows a front view of 3D printed table, according to an example embodiment.

FIGS. 3A-3B shows an isometric view of 3D printed cloth for a lamp according to an example embodiment.

FIGS. 4A-4C show front view of 3D printing arrangement for priming on an uneven surface according to an example embodiment.

FIG. 5A show a schematic view of producing 3D printed filament materials according to an example embodiment.

FIG. 5B shows an wound filament materials according to an example embodiment.

FIGS. 6A-6B show arrangement for printing an article of manufacture according to an example embodiment.

FIGS. 7A-7D show various steps involved in forming a 3D structure according to an example embodiment.

FIG. 8 shows an isometric view of 3D printed object by combining two or more object according to an example embodiment.

FIG. 9 shows inline hybrid material lamination with colored 3D-printing and laser cutting of hybrid materials according to an example embodiment.

FIGS. 10A-10C show steps involved in cross-linking different materials to form 3D layer according to an example embodiment.

FIGS. 11A-11C show an arrangement for printing on a cylindrical object such as a cup according to an example embodiment.

FIGS. 12A-12C show functional articles formed using 3D printing method present disclosure.

### DETAILED DESCRIPTION

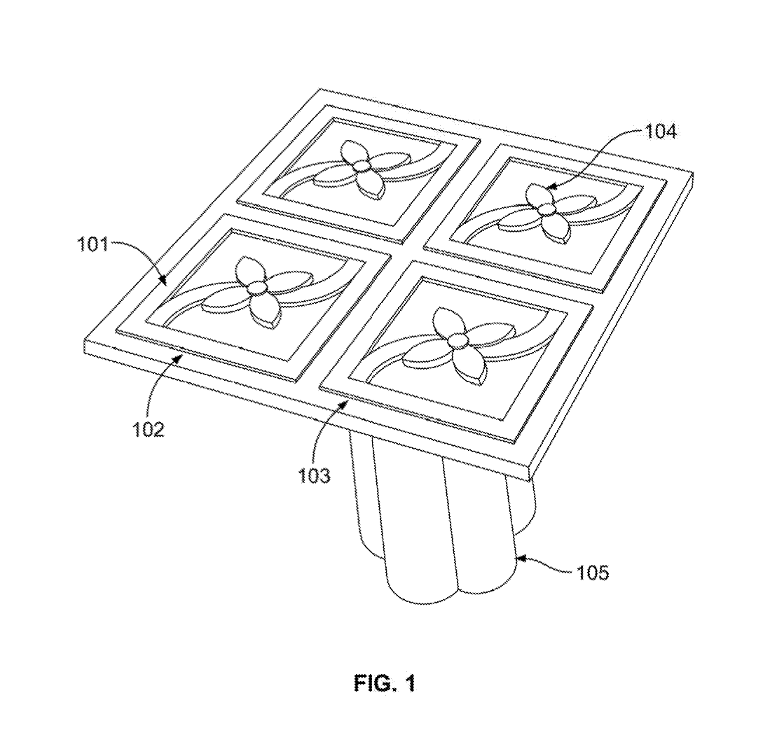

FIG. 1 is an example application of glass and plastic laminated pieces combined with three-dimensional material deposition methods to create structures that combine various materials and intermediate compatible materials such as adhesives. Adhesives may include but not limited to EVA, TPU, and Silicone which would be cured at room temperature or autoclave.

In an example embodiment, the top 101 can be glass, ceramic, tile, or metal etc. and can be bonded to polymer tie layer 102. The polymer fie layer 102 may include adhesive and polymeric film such as PET/PC. The polymeric film is effectively bondable to the 3D printable material. 3D printed flower design of FIG. 1 is fabricated by placing the four tiles/laminates on 3D printing bed. The printing nozzle/extruder then deposits a bondable compatible material (103, 104, 105) on the tiles to forte the remaining structure. Upon completion of deposition and cooling, the structure is inverted to bring the base 105 to contact the floor.

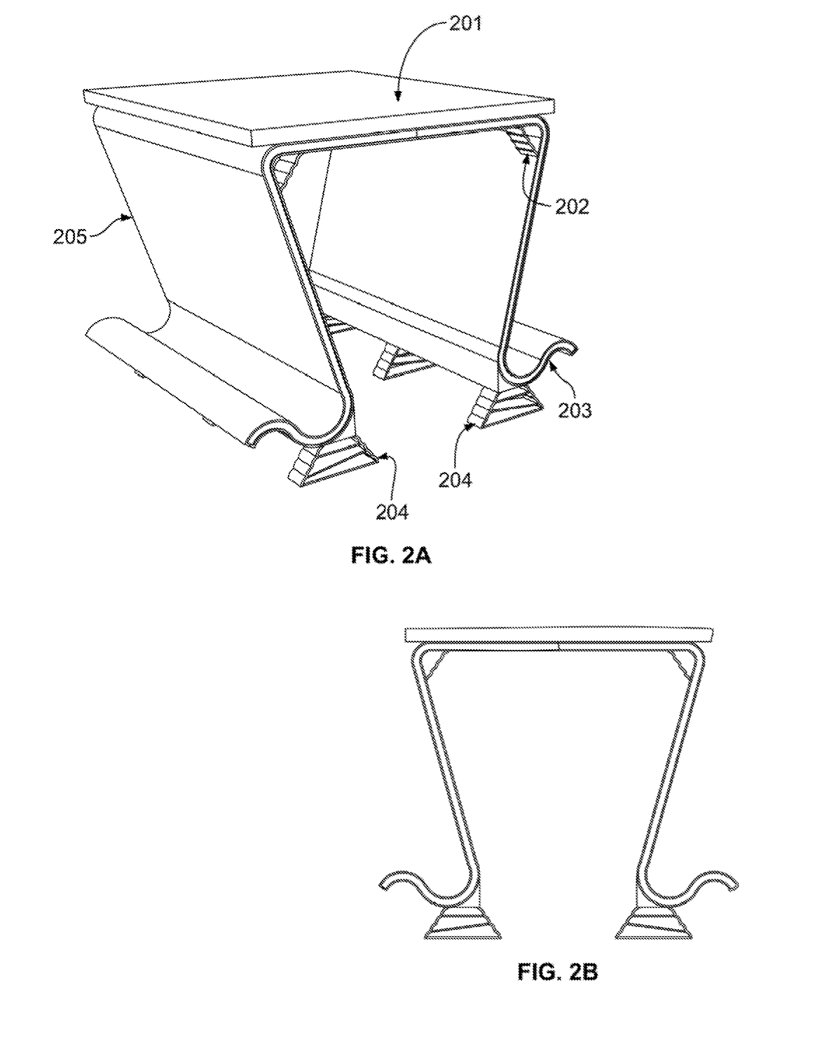

FIG. 2 shows an example of Thermoformed plastic sheet in table shape and feed feet/legs/support made from three-dimensional layer deposition to make a complete structure with a strong bond. Thermoformed step may be done before or after the 3D printing.

In an example embodiment, 201 can be 0.25″ thick glass, laminated with adhesive and. polymer sheet.

In an example embodiment, 202 can be a 3D printed or mounted support four sides.

In an example embodiment, 203 can be a formed part of the sheet.

In an example embodiment, 204 can be mounted or cart be 3D printed legs with the inside support structure. In an example embodiment, 205 can be a one-piece polymer sheet and is about 0.75″ thick.

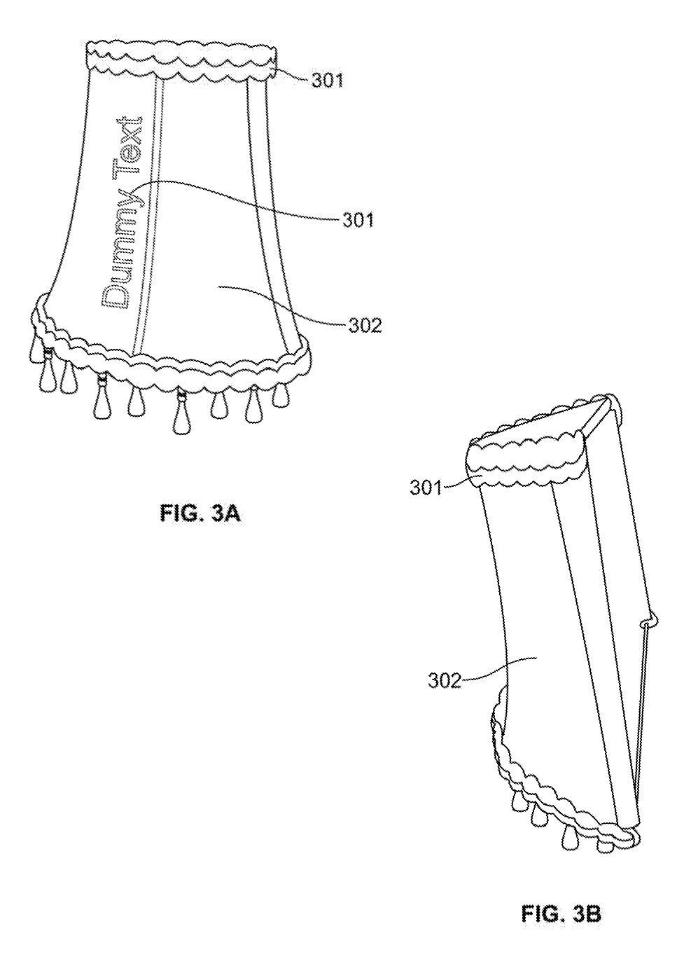

FIG. 3 shows a cloth laminated to plastic film such as Polycarbonate, Polyethylene Terephthalate. Adhesives or bonding media may include but not limited to low temperature or room temperature adhesives such as two-part epoxy, UV curable adhesives, certain hot melt adhesives, or pressure sensitive adhesives (silicone or acrylic based).

In an example embodiment, 301 can be a 3D printed custom design or wording.

In an example embodiment, 302 can be a cloth and can be bonded to polymer tie-layer for 3D printing.

In an example embodiment, direct plug-in or table lamp structures can be built by combining various materials. A fabric 302 can be laminated to tie layer (polymer) using various methods. The tie layer (which is compatible with 3D printable material) is exposed to allow 3D printing 301.

In an example embodiment, the fabric 302 can be on the outside or inside of the structure. The polymer tie layer would be behind the fabric to allow 3D printable custom designs or wordings 301.

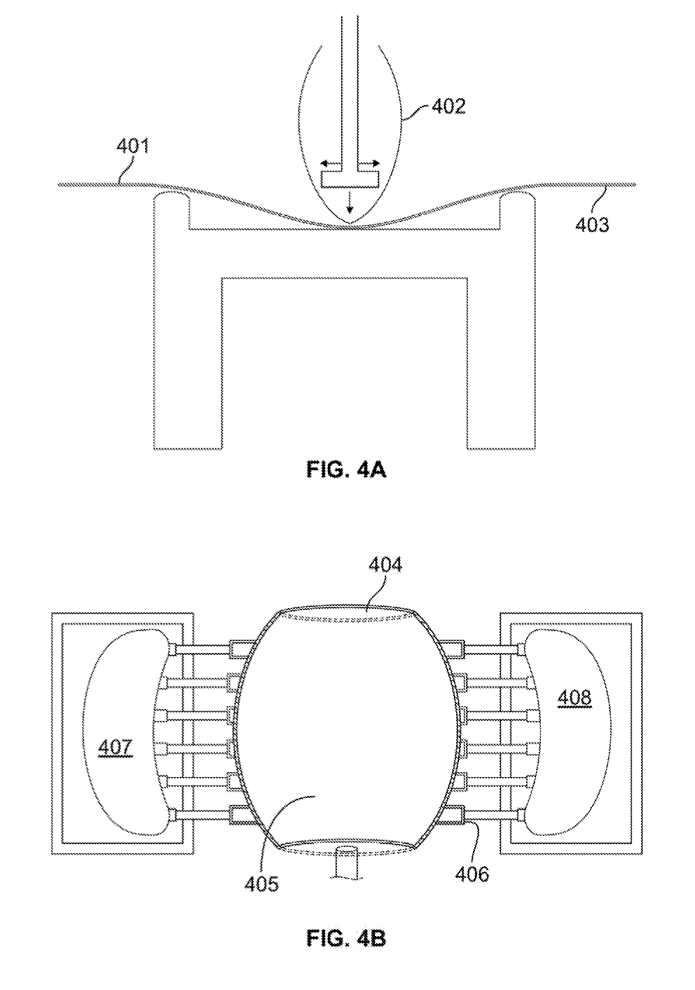

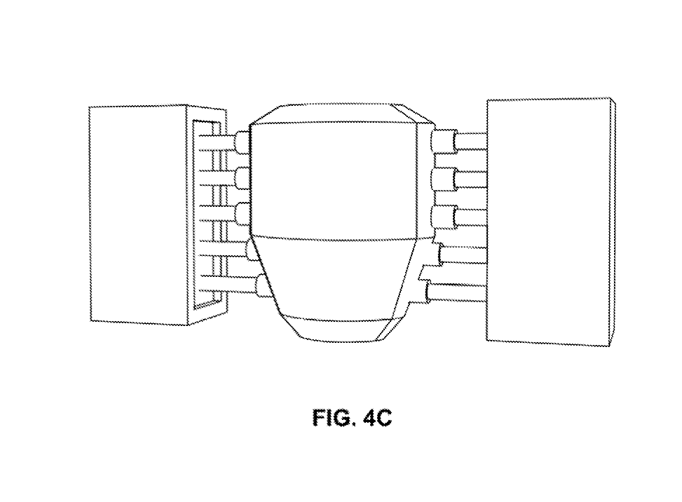

FIG. 4 shows a method of in line lamination on 3D printing deposition apparatus for above-stated examples using a pressure sensitive adhesive. FIG. 4 also shows a method to hold an object which may be curved or flat. Various clamping, turning, mounting, work-holding devices activated using but not limited to the hydraulic, pneumatic, or electromagnetic mechanism. This increases the speed of printing as the object is premade/existing and 3D printing is performed on the surface of the object.

In an example embodiment, object 405 can be clamped as the example shown in FIG. 4B, using soft touch pins 406 and balloon 407 and 408.

In an example embodiment, polymer tie layer 401 with adhesive 403 on one side of bonding is attached to the object using robotic placement application using an expandable balloon (402). 3D printing is then performed on the compatible surface 404.

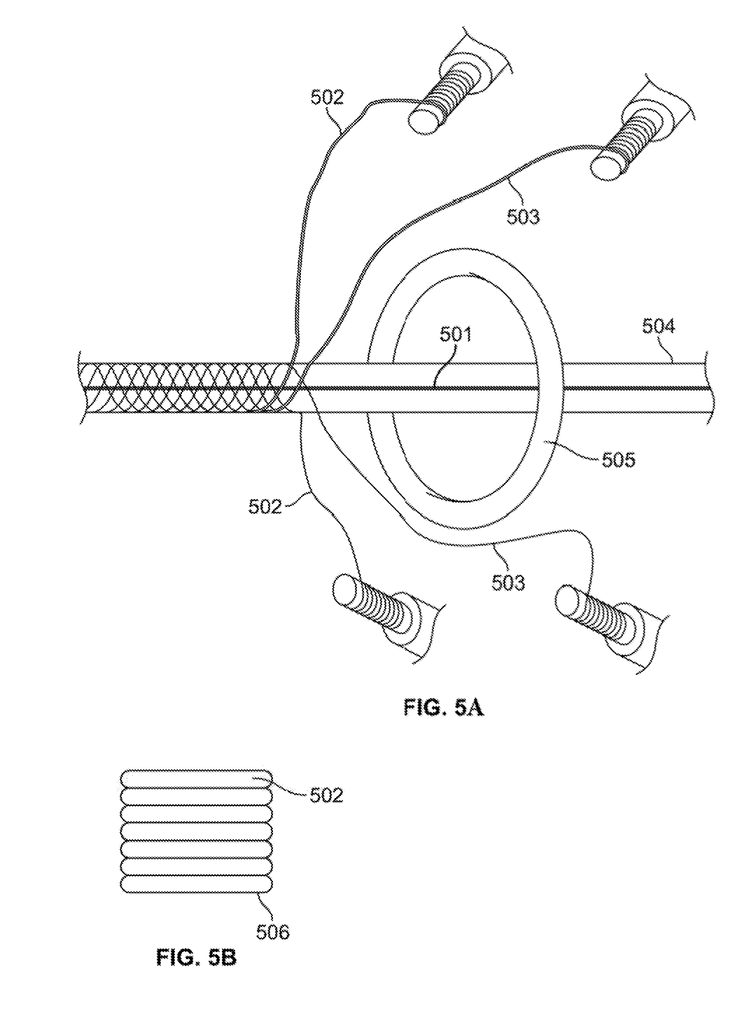

FIG. 5 shows a method to make the filament for 3D printing. In an example embodiment, a filament is wound or coated with a material exhibiting Functional Surface Response Stimuli (FSRS) behavior. The FSRS material coating 500 may be preprocessed or processed on-demand/online or post processed to 3D printing/deposition. in an example embodiment, the FSRS material 500 may be ink, coating material, cross-linkable materials that may be activated using the electrical field, magnetic field, UV light or heat. FIG. 5 shows a filament layer 501 wounds around an object 502. In an example embodiment, the filament layer 501 is comprised of fiber material coated with FSRS material that when used for 3D printing may be activated with heat to crosslink with a plurality of layers to form one object. This process increases the strength between layers of deposited material thus strongly bonding the entire printed object. This also allows strong bond with the pre-made object.

In another example embodiment, FIG. 5A shows schematic of producing 3D printable filament materials. The outside of filament is wound with cross-linkable material 502 and reinforced with continuous glass fibers 503. The main polymeric mono filament 504 may be pre-extruded with fiber bundle 501 such as metal, glass etc. Materials 502, 503 and can be wound on 3D printable filament 504 using reheating/sizing ring 505 for embodiment. When the filament is used with 3D printing equipment each layer cross-links with an adjacent layer with thermal curing as shown in FIG. 5B.

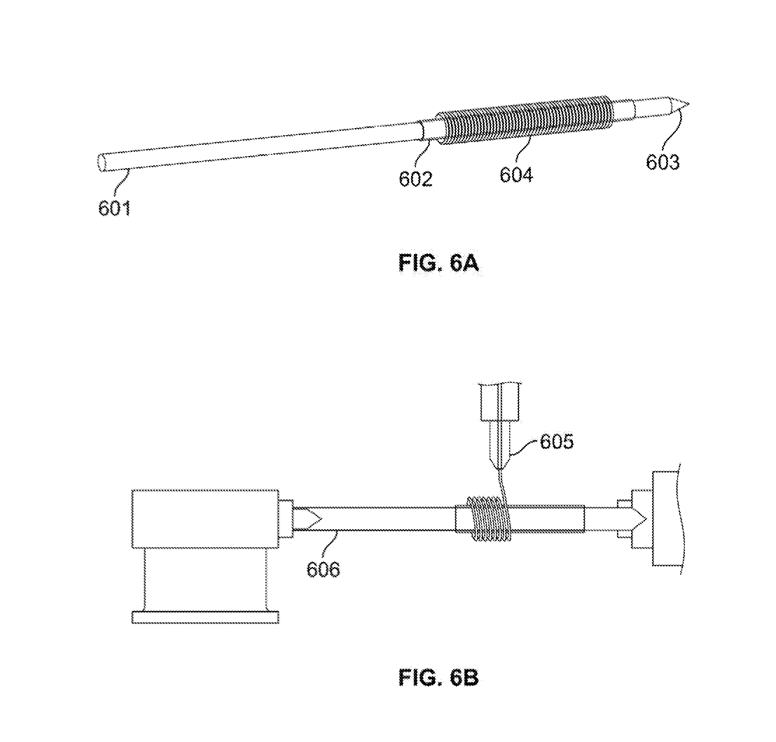

FIG. 6 shows apparatus addition to the existing 3D printing/deposition set-up to build features that require the existing object to revolve around any axis while allowing the deposition process. For example, as the FIG. 6 shows a pen refill tube 600 is mounted between two centers/chucks 603 allowing the tube to revolve under the deposition nozzle 601 and allowing a desired shape and diameter of the printed layer be formed along with the refill tube 600. The refill tube 600 may be built with the soft material forming a grip such as a new pen, eliminating the need for the user to buy a whole pen but create a pen on demand with desired customization of colors or prints.

Using the inventive aspect of this technology, there is no need to buy the whole pen but just need to buy the refill tube and the desired grip may be printed. Grip diameter based on user's hand size and desired comfort may be printed (use of different TPE material) and can customize with colors, names or logos. Thus, a pen that is customized to fit in hands/fingers of every unique individual may be printed. A refill tube 601, 606 can be coated with compatible polymer 602 application for 3D printing as shown in 605. The 3D printing can be performed using equipment also shown in FIG. 4.

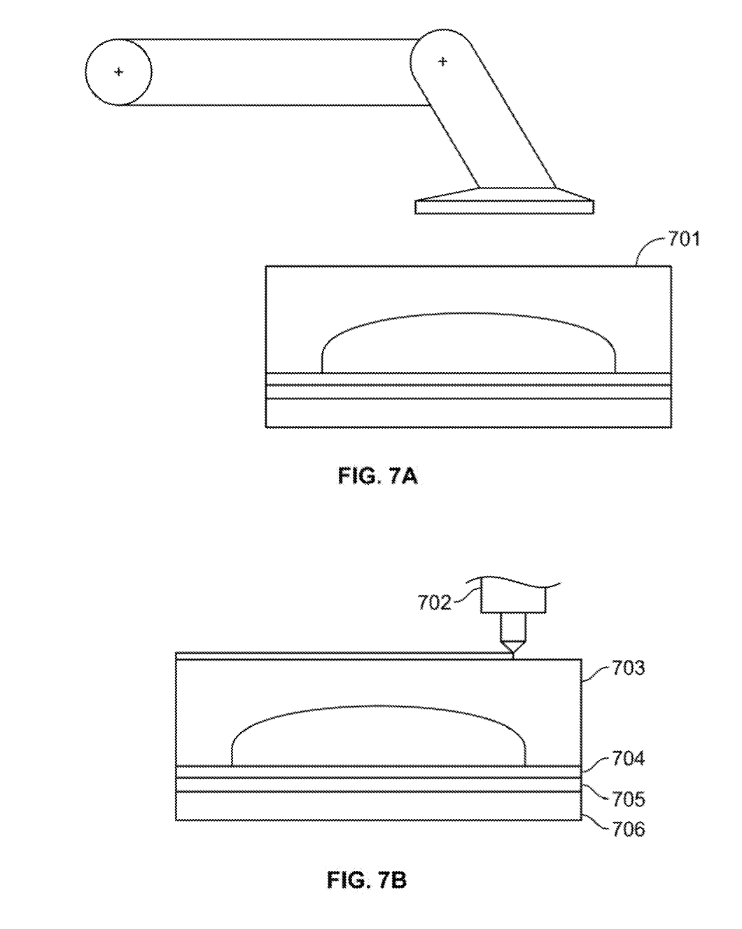

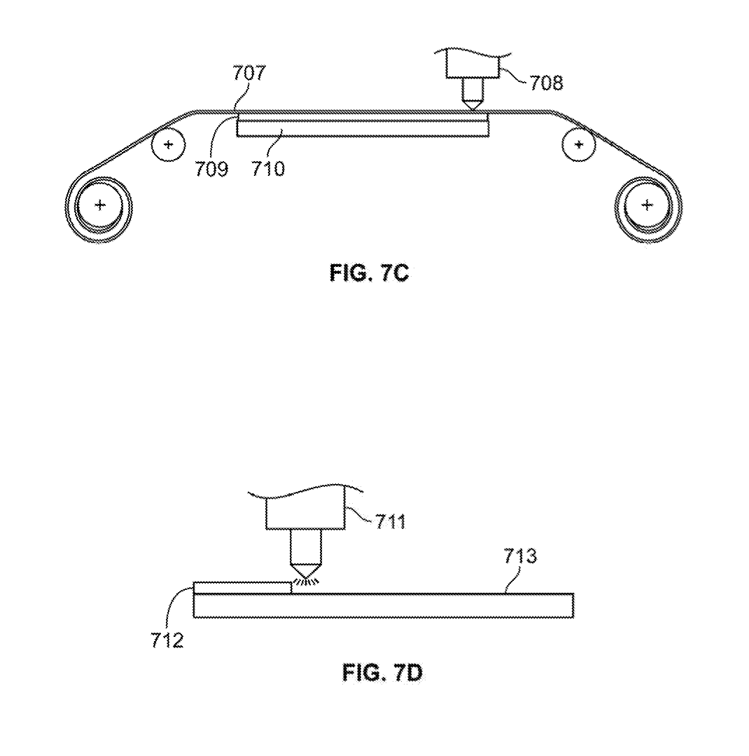

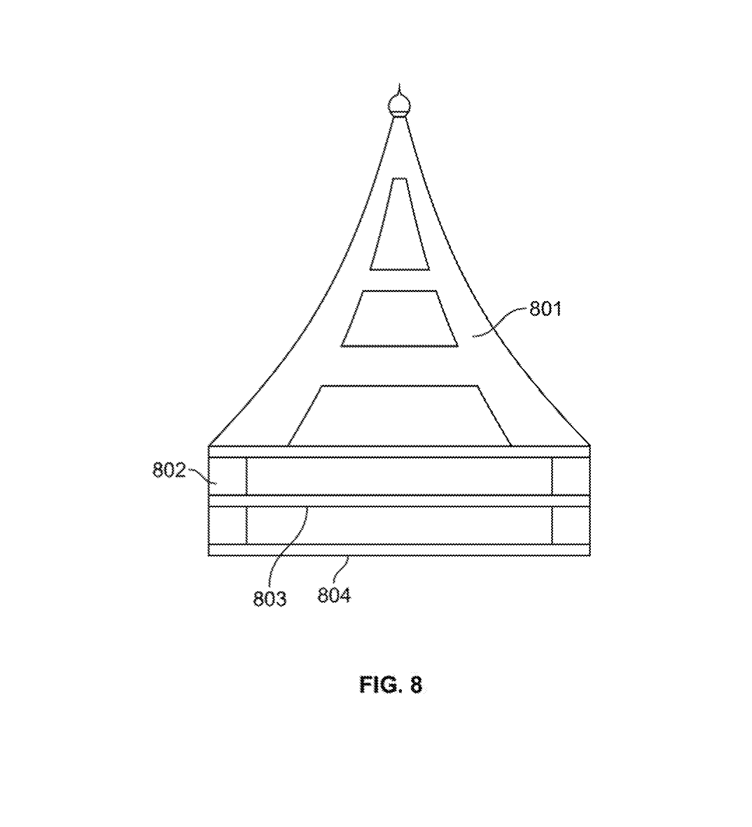

FIG. 7 shows apparatus with the robot and inline lamination. A robot may be used to place one or more objects 801, 802 in a midway of 3D printing/deposition to enhance the new structure 800 (as shown in FIG. 8). The objects may include necessary adhesives/intermediate bonding materials. The end of the robot arm may also be equipped with dispensing head. Before the object is placed, the structure beneath is solidified or made strong enough to hold rest of the build structure or deposition.

For an automated, process of continuous or large part 3D printing, adhesive 712 is applied to object 713. The base compatible film 707 is placed on bond to the adhesive and cut to size using laser 708. 3D printing deposition is performed by nozzle 702 to build the desired structure. Multiple or different materials is used in 713 can be used in 701 using a robot.

FIG. 8 shows an example structure built with apparatus and method described in FIG. 7. This structure or part has flexible stand-off legs and has objects 801, 801 (metal, polymer, glass, ceramic, paper etc. with compatible film/adhesive layer) placed at various levels of the part/structure. After the base structure is built as shown in FIG. 7, remaining structure 801 is built to complete the structure for functional or decorative purposes.

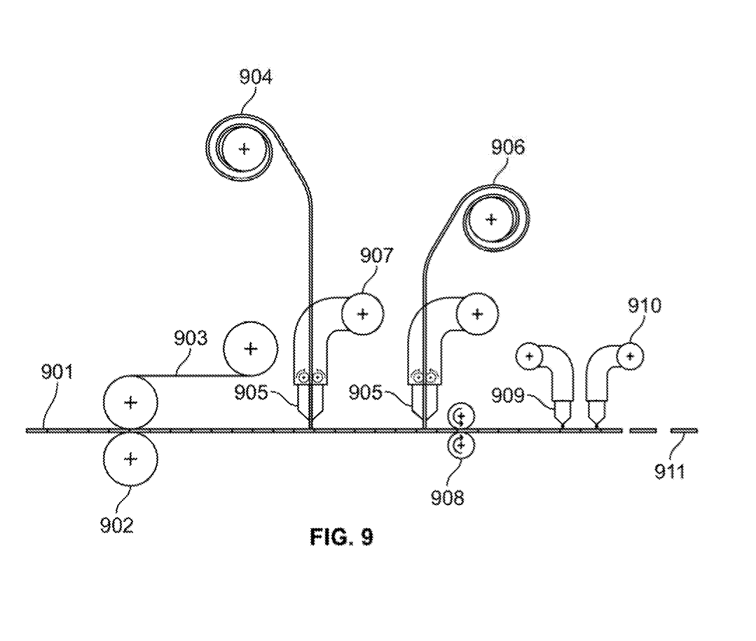

FIG. 9 shows continuous and semi-continuous process design with in-line 3D printing to produce desired features, structures or articles with the hybrid material at the base of the structure. In an example embodiment, after a roll or continuous material is passed through the process, the cutting method can be laser cutting to produce no micro-cracks or using waterjet cutting as an alternative.

In another example embodiment, the apparatus of FIG. 9 may be used inline hybrid material lamination with colored 3D printing and laser cutting of hybrid materials. Dissimilar materials can be fed in different forms to create functional and artistic products for high-speed manufacturing. One form of material (such as metal, polymer, ceramic, wood, glass etc.) as sheet or film can be fed from 901. Primary nip 902 laminates the fed material with compatible tie layer (such as polymer adhesive and film). Printer head 905 can print multiple material or colors through multiple printer heads on to the tie (polymeric) layer. Laser heads 909 and 910 (or other cutting methods) can be used to cut dissimilar materials. For example, hollow beam YAG laser can be used to cut polymeric materials and CO2 laser can be used to cut glass or hybrid materials. Finished product with in-line packaging or further processing and assembly is performed.

The equipment can be used for origami type functional products for honey comb paper or similar processing. In addition, this may include 3D printing, dissimilar material assembly, lamination and cutting to final shape.

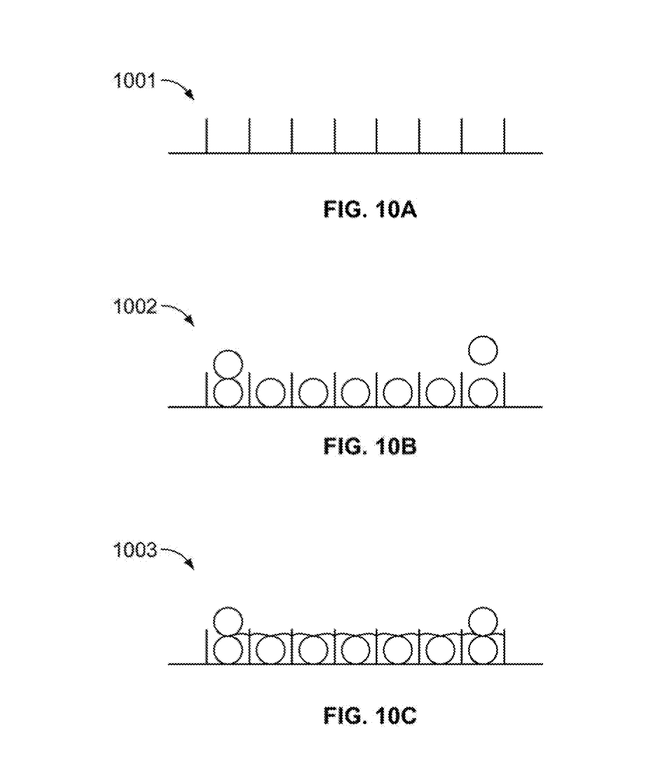

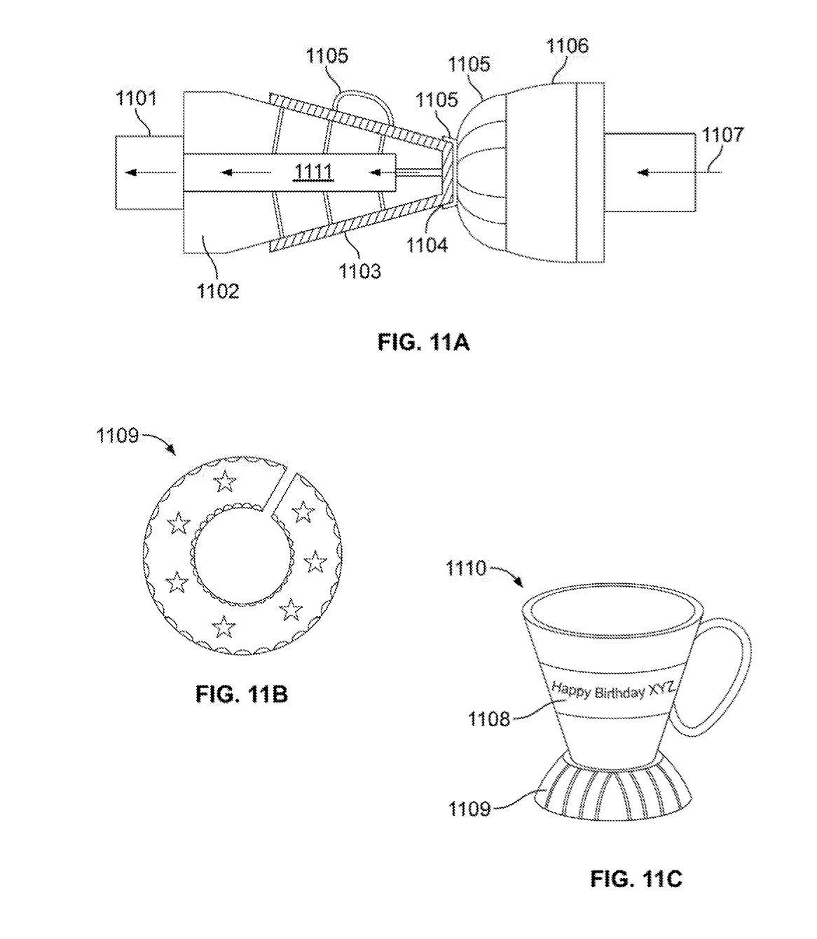

FIG. 10 shows fibers, texture or feature that can subsequently provide stronger bond by thermal, chemical or mechanical methods. The compatible polymer includes, but is not limited to, polycarbonate, PET for the thermal bond. For the chemical method, the material used may include, but is not limited, to cross-linkable polymers such as epoxy, polyurethane, acrylic or photopolymers. For the mechanical method, bonding materials may include but not limited to hook and loop, snap features, ultrasonic welding. The fibers include a heat and cross-linkable material commercially available that can entrap the first layer deposited by 3D printing.

In an example embodiment, textured film can be used as a tie layer for additional strength bond with the 3D printing of the first layer. To address the challenge and further enhance bonding of 3D printing (of the 1st layer) on dissimilar materials, the surface can be prepared with many different textures on the compatible layer. This includes cross-linkable fiber 1001 with open loop ends. After the 3D printable 1st layer 1002 is deposited, the fibrous open loops or textures close under heat or other cross-linkable methods such as UV light. This bonding method can be permanent for industrial applications or semi-permanent bond for house hold applications such as hook and loop bonding e.g., Velcro), which can be (reused) by bonding or remove the bond as needed.

The film used as a base for 3D printing can be textured, micro textured or nano-textured. The texture or feature can subsequently provide stronger bond thermally, chemically or mechanically. The compatible polymer includes, but not limited to, polycarbonate, PET for the thermal bond. The chemical material may include but not limited to cross-linkable polymers such as epoxy, polyurethane, acrylic or photopolymers. For mechanical bonding, materials may include but not limited to hook and loop, snap features, ultrasonic welding.

FIG. 11 shows an example embodiment of pre-made objects, for example, pre-made cups 1100, made up of styrofoam that allows depositing 3D printing on its surface for the decorative or functional purpose. The material of such pre-made cup is not limited to Styrofoam. The base of the cup may have film deposited under vacuum to add to the decoration or personalization. On the shaft (1101) an object such as a plastic cup (1103) is placed with vacuum (1111) to hold the cup in place while the shaft is rotating (1101). 3D printing (1105) can be deposited on tie layer film (1104) or directly on a plastic cup. To support the 3D printing structure, an inflated support structure (1106) can be incorporated utilizing compressed air (1107).

The tie layer can consist of pre-printed graphic, deconstructive (1109) or can be thermoformed on the 3D printed structure. With the later approach, thermoforming is easily performed due to porous nature of 3D printed structure (1105).

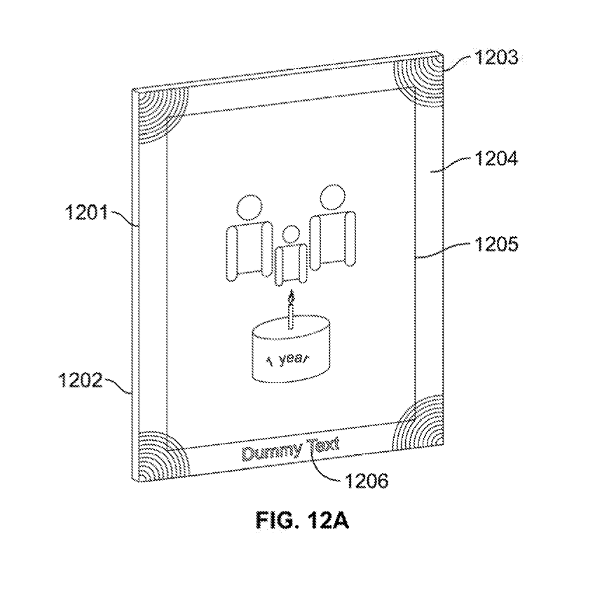

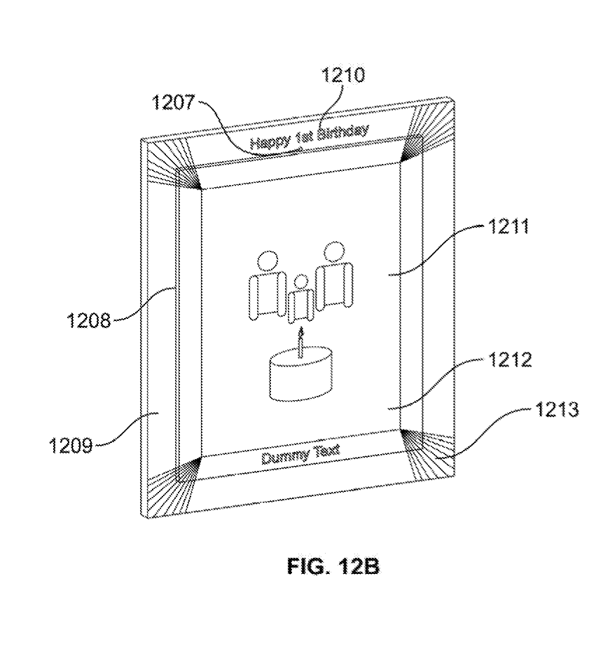

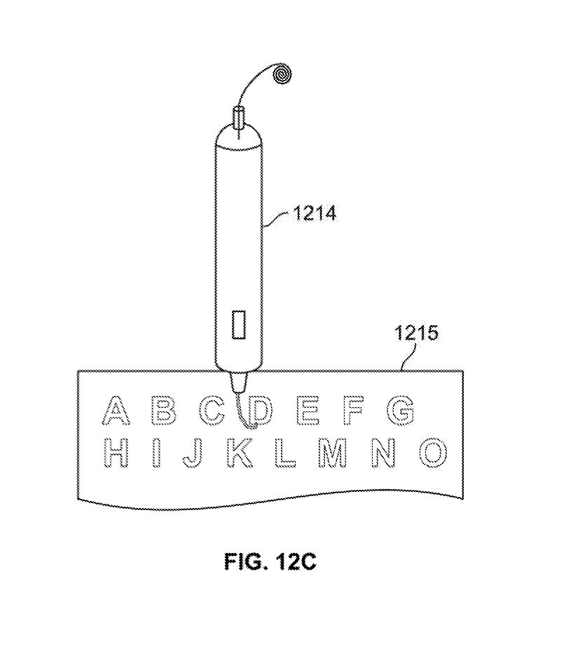

FIG. 12 shows hand making for new articles using existing articles, A special stencil is used to add wording, decoration or personalization on an existing photo. In an example embodiment, a photo 1200 is placed on hybrid material 1201 (base with the compatible material) an example may include but not limited to wood 1202 with a film bonded to the surface. In another example embodiment, a laminated photo may be used to build a frame around the photo. The stencil 1203 allows for hot tip nozzle of a hand-held 3D printer pen to be traced. It may be flexible and allows the use on curved surfaces.

Low cost, house hold, the 3D printing system can be made available utilizing simple tools to produce functional and beautiful articles such as shown in FIG. 12. Starting with a sheet 1201, which can consist of any desired materials such as wood, metal, glass, plastics, etc), if non-polymeric (or incompatible) material is chosen, then a tie layer can be laminated using document laminator with standard laminating film pouches (1204). Commercially available hand held 3D printing pen (1214) can be used with desired colors filaments.

In an example embodiment, a custom photo frame shown in FIG. 12 can be created by placing a photo 1205 on laminated sheets 1201, 1202 and 3D print 1203, 1206, 1213, 1210 around the photo. A metallic or any heat resistance stencil 1215 can be used to write letters 1206, 1201 special characters or free hand writing 1203, 1213. The photo holder can be the radius, straight or any design 1213, 1203.

Building a three-dimensional effect or structure with a strong bond may be achieve on any surface such as on wood, stone, paper, ceramic, rubber/polymer, sponge/foam, cloth, glass, cement, building structures or metals. Before application of the 3D structure, the surface is prepared with at least on a layer of bonding material that can bond the subsequent layer. This bonding material may comprise an adhesive layer and compatible layers such as thermoplastic film or coating. This thermoplastic layer is used such that it withstands the heat of the subsequent layer. The adhesive layer may be softer, pliable to provide maximum surface area for the first layer of deposited material thus enabling optimum bond. Additionally, the pressure and height of the depositing nozzle, layer width and thickness is selected to achieve optimum or desired bond.

The thermoplastic layer may be crumbled, dissolved, disintegrated or vaporized to expose the adhesive layer to the first layer, of deposited material.

In one of the embodiments, the building of a three-dimensional effect or structure with a strong bond can be done on any surface such as on wood, stone, paper, ceramic, rubber/polymer, sponge/foam, cloth, glass, cement, building structures or metals. Before application of the 3D structure, the surface is first prepared with the at least on a layer that can be bonded with the subsequent layer. This bonding material may comprise the adhesive layer and compatible layers such as thermoplastic film or coating. This thermoplastic layer must withstand the heat of the subsequent layer. The adhesive layer may be softer, pliable to provide maximum surface area for the first layer of deposited material thus enabling optimum bond. In a further example embodiment, the pressure and height of the depositing nozzle, layer width and thickness may be selected to achieve an optimum bond. The thermoplastic layer may be crumbled, dissolved, disintegrated or vaporized to expose the adhesive layer to the first layer of deposited material. The adhesive layer includes thermoset (silicone, acrylic) polymer adhesive layer.

According, to the present disclosure, certain materials such as plastic and glass may be bonded using adhesives such as to EVA, TPU, and Silicone which can be cured at room temperature or autoclave. Other adhesives may include but not limited to low temperature or room temperature adhesives such as two-pan epoxy, UV curable adhesives, certain hot melt adhesives, or pressure sensitive adhesives (silicone or acrylic based). If adhesive layer provides some cushioned bond, the first layer of 3D print remains strong.

According to the present disclosure, one option for this surface is to be any flexible material such as cloth, canvas, film, metal mesh etc. The second option for this surface is to be a rigid object. On a desired location of the object, 3D printing can be performed. A layer on top (of above adhesive layer) can be formed by applying a thermoplastic layer for example—PE/PET film, PC film, powder, or liquid. Now, 3D printing on top of this thermoplastic is performed to build functional structures.

According to the present disclosure, 3D printing or additive manufacturing can be done with a commercially available handheld devices or standalone units. An automated way of adhesive film application can be used. Such as expandable balloon to stick on a caved surface. The excess film can be pre-perforated or cut using a laser. The desired surface on an object described

According to the present disclosure one method being use of inflatable shafts with grips in the form of strips or cups or clamping pins. 3D printing on a thermoformed or formed flexible material. Build thermoforming tool with high-temperature materials such as Polyetherimide, PEEK or metal additive manufacturing. As the CNC coordinates of the tool are known to the machine, this will be an advantage for 3D printing. In the same process lay down a film bonded to cloth or any flexible material such as film or metal mesh. While the above parts on the same tool apply an adhesive film to bond to metal. The third 3D print on a plastic surface. Method to produce cross-linkable and reinforced material for 3D printing as shown in the picture the cross-linkable fiber and reinforcing fiber is wound around a standard 3D filament.

According to the present disclosure, the cross-linkable fiber may include but not limited to Nylon fibers with a crosslinking agent as coatings or inherent material formulations. The reinforcing fibers may include but not limited to glass fiber, carbon fiber or any reinforcing fibers. When the fibers are wound around the 3D printing filament by passing through the nozzle, the filament would heat activate the cross-linkable material. When one layer comes in contact with another layer the cross-linking between layers would occur and solidify upon cooling. The crass-linking material can also be applied using spraying material on the outside of 3D printing structure during or after 3D printing.

A layer of thermoset (silicone, acrylic) polymer adhesive on a surface. Few of such adhesives are shown in Laurin et. al publication WO2016007743 A1.

To bond certain materials such as plastic and glass, such adhesives may include but not limited to EVA, TPU, and silicone which would be cured at room temperature or autoclave. Other adhesives may include but not limited to low temperature or room temperature adhesives such as two-part epoxy, UV curable adhesives, certain hot melt adhesives, or pressure sensitive adhesives (silicone or acrylic based).

If an adhesive layer provides some cushion for the first layer of 3D print, the bond remains strong. Next layer above the adhesive layer can be formed by applying a thermoplastic material. Example PE/PET film, PC film, powder, or liquid, thus, forming a tie layer for subsequent 3D print structures. This tie layer would provide a strong bond to hold functional structures.

In an example embodiment, a surface used in the article of manufacture may be the surface of a flexible material such as cloth, canvas, film, metal mesh etc. In another example embodiment, the surface may be containing any rigid material. On a desired location of the object. 3D printing can be performed thus providing selective reinforcement.

In another example embodiment, 3D printing or additive manufacturing can be done with a commercially available hand held devices or standalone units.

In a further example embodiment, an automated way of adhesive film application can be used. Such as expandable balloon to stick on a curved surface. The excess film can be pre-perforated or cut using a laser. The film forms a tie layer for a strong bond with 3D printing through with various methods. Any existing article can be held by inflatable shafts with grips in the form of strips or cups or clamping pins for subsequent 3D printing on the article as shown in FIGS. 4A-4C.

The technology also allows 3D printing on any industry standard fabrication components including thermoformed or formed flexible material. In order to perform this a thermoforming tool must be built with any high-temperature materials such as Polyetherimide, PEEK or metal additive manufacturing. The machine building the base components need to have computer numerical controls (CNC) coordinates to build subsequent structures upon it. To enable 3D printing on recently such fabricated components, tie layer needs to be applied that is compatible. This may include polymeric tie layers to bond with polymeric 3D printing material. Additionally, film bonded to cloth or any flexible n atrial such as film or metal mesh with the tie layer can be applied. 3D printing on dissimilar materials to build small or large structures can be performed. If stiff materials are used as a support, functional structures, the material need to be prefabricated or cut in-line before application.

As shown in the picture the cross-linkable fiber and reinforcing fiber is wound around a standard 3D filament. The cross-linkable fiber may include but not limited to nylon fibers with cross-linking agent as coatings or inherent material formulations. The reinforcing fibers may include but not limited to glass fiber, carbon fiber or any reinforcing fibers. As the fibers are wound around the 3D printing filament, while passing through the nozzle, the filament heat activates the cross-linkable material. When one layer comes in contact with another layer, the cross-linking between layers occurs and solidifies cooling. The cross linking material can also be applied using spraying material on the outside of 3D printing structure during or after 3D printing.

In another example embodiment, a method of making filament with functional surface response stimuli is achieved by using fibers or coating on the outside of filament. The core of the filament may include functional or reinforcing material such as metal or glass fibers, as shown m FIG. 5.

We claim:

1. A method for three-dimensional printing, the method comprising:
preparing a surface of a pre-made object by depositing at least one adhesive layer on the surface, wherein the adhesive layer is adapted to bind the surface of the object With a compatible layer;
depositing the compatible layer on the adhesive layer;
three-dimensional priming on the prepared surface by,
depositing at least a first material on the compatible layer b a deposition tool head to create a predefined structure on the pre-made object, the predefined structure including an article and an effect.

2. The method of claim 1, wherein the first material includes functional surface response stimuli (FSRS) material exhibiting functional surface response stimuli (FSRS) behavior.

3. The method of claim 2, wherein the object comprises a refill object that has a predefined structure having a surface area made compatible with a three-dimensional printing material.

4. The method of claim 3, wherein the object includes at least one of metal ceramic, glass, polymers, paper, fabric, concrete or a combination thereof.

5. The method of claim 3, herein the FSRS material includes an ink coating material.

6. The method of claim 3, wherein the FSRS material include a cross-linkable material that can be activated using an electrical field.

7. The method of claim 3, wherein the FSRS material include cross-linkable materials that can be activated using a magnetic field.

8. The method of claim 3, wherein the FSRS material include cross-linkable materials that can be activated using UV light or heat.

9. The method of claim 3, wherein the at least the first material includes the filament material coated with FSRS material.

10. The method of claim 3, wherein the refill object is provided via online service.

11. A method for three-dimensional printing, the method comprising:
in a first step,
preparing a fast surface of a first object by depositing at least one first adhesive layer on the surface, wherein the first adhesive layer is adapted to bind the surface of the first object with a first compatible layer;
depositing the first compatible layer on the first adhesive layer;
three-dimensional printing on the prepared first surface by,
depositing at least a first material on the first compatible layer by a first deposition tool head to create a predefined structure on the first object, the predefined structure including a first article or a first effect;
in a second step,
preparing a second surface of the predefined object by depositing at least second adhesive, wherein the second adhesive layer is adapted to bind a third surface of premade article;
preparing a third surface of a pre-made article by depositing at least one third adhesive layer on the third surface, wherein the third adhesive layer is adapted to bind the third surface of the pre-made article object with the second surface of the predefined object;
attaching the third surface of the pre-made article with the prepared second surface of the predefined object; and
repeating a combination of the first step and second step to obtain the desired effect and a composite article.

12. A method for three-dimensional printing, the method comprising:
forming a partial structure of a first object by a combination of inline built thermoforming or stamping tool and CNC (Computer Numerical Control) use of position coordinates;
preparing a first surface of a first object by depositing at least one first adhesive layer on the first surface, wherein the first adhesive layer is adapted to bond the first surface of the first object with a first compatible layer;
depositing the first compatible layer on the first adhesive layer;
three-dimensional printing on the prepared surface by,
depositing at least a first material on the first compatible layer by a first deposition tool head to create a first predefined structure on the first object, the predefined structure including a first article or a first effect;
preparing a second surface of a second object by depositing at least one-second adhesive layer on the second surface, wherein the second adhesive layer is adapted to bind the second surface of the second object with a second compatible layer;
depositing the second compatible layer on the second adhesive layer;
depositing at least a second material on the second compatible layer by a second deposition tool head to create a second predefined structure on the second object, the second predefined structure including a second article or a second effect.
